(19) United States
(12) Patent Application Publication
(10) Pub. No.: US 2016/0258124 A1
(43) Pub. Date: Sep. 8, 2016

(54) Magnetic Inductive Rail Switch Heater

(71) Applicant: Jeffrey Ross Johnston, Jacksonville, FL (US)

(72) Inventor: Jeffrey Ross Johnston, Jacksonville, FL (US)

(21) Appl. No.: 15/062,290

(22) Filed: Mar. 7, 2016

Related U.S. Application Data
(60) Provisional application No. 62/128,851, filed on Mar. 5, 2015.
(60) Provisional application No. 62/166,497, filed on May 26, 2015.

(51) Int. Cl. E01H 8/08; H05B 6/10; H05B 6/06; H05B 6/04; H05B 1/02

(52) U.S. Cl. CPC E01H 8/08; H05B 6/04; H05B 1/0244; H05B 6/06; H05B 6/101

(57) ABSTRACT

A heating system for a train track rail, coal car, and other comparable units contains a main power supply, a system control unit, a plurality of environmental sensors, and a plurality of induction heating units. The plurality of environmental sensors is used to maintain a constant feedback of the environment the heating system is used in. Each of the plurality of induction heating units includes a heating head which is used to generate heat. In particular, the heating head generates heat through a pancake induction coil. The generated heat is used to melt snow or ice which accumulates on the train track rail. Since each of the plurality of induction heating units can be controlled individually, energy usage is minimized.

The current application claims a priority to the U.S. Provisional Patent application Ser. No. 62/128,851 filed on Mar. 5, 2015 and U.S. Provisional Patent application Ser. No. 62/166,497 filed on May 26, 2015.

### FIELD OF THE INVENTION

The present invention relates generally to a railway switch heater. More specifically, the present invention introduces an inductive heating head that is used to heat a rail and prevent the accumulation of frozen material. The present invention enables railway operators to ensure that properly equipped rail switches will function unhindered in freezing temperatures.

### BACKGROUND OF THE INVENTION

Switch tracks, used to transfer train direction from one track to another, depend on precision joints within the switch that move and transfer movement of a train to another track. In winter months, snow and ice may build up within the joints preventing the drive motors or linkages from being able to shift position. This problem is typically solved by heating the rails to melt the snow and thus clear the obstacle.

As one of these heating systems, small smudge pots were used to provide open flame heating to sections of the rails. They are oil-filled and lit by hand much like an oil lamp using a wick to draw up the fuel to the top of the unit.

Next, open flame gas was used to deliver gas along the 30-foot section of rail that needs to be heated. As open flame is somewhat dangerous, and expending vast amount of gas was expensive, the rail road's moved to new sources of heating the rails.

Another common type of switch heater used is an electric resistive heating element that is attached along the rail for the 30 feet of the switch. Within a single switch, you would have two 30-foot long elements pulling 300 watts per foot at 480 VAC using 90 amps per phase. Also needed in this system are several smaller heating resistive units called crib heaters which add to the total load of the system. This system depends on thermal transfer from the outer element across an air gap and into the rail.

Hot air blowers are also used to heat railroad tracks. When used, these units use a blower to push air into a duct system and deliver air to the rail bed. The air is heated by means of either gas fired burners of passing the air over electric restive elements. The combined amperage of the blower motor and the heat source makes these units the most expensive units to operate in the field.

The present invention intends to address the aforementioned issues. In doing so, the present invention uses a magnetic inductive heating coil to introduce heat directly into the core of the rail with reduced levels of electrical energy needed to create higher levels of heat into the rail. Lab Test using 120 VAC has used as little as 5 amps to heat the rail to 220 degrees well above the 98 degrees needed. Also of note, all of the above systems need to be removed from the rails when routine track maintenance is conducted as the equipment used will damage the parts if left in place. This will not be the case with the new inductive heating heads. These small rugged coils of the present invention will be affixed to the rail in a manner that the rail maintenance equipment will not effect as the equipment passes over the area they are installed. By having multiple standalone heads, should one fail, the others will continue to operate unlike the Calrod system. In contrast, when one of the Calrod elements burn out or fail, the entire 30-foot section fails; thus shutting down the switch for rail traffic.

The inductive heads can be attached on the side of the rail or the underside of the rail. Lab testing has shown how rapid the rail is heated, given several power level settings on the equipment. The coils within each of the heads may be potted to ensure it will remain waterproof and vibration resistant.

The Inductive Heating System of the present invention will comprise multiple heating heads (depending on the size of the rail road switch) wired back to a central control panel located beside the tracks. Within the control cabinet will be the electrical power fusing, control relays, GFI protection unit, snow-detectors, thermostat, and a small PLC unit to allow for system operational programming.

The technology introduced through the present invention can produce 1800 watts at 120V single phase directly into an eight-inch section of the rail with zero heat loss. This means that the heads will be placed at various intervals along the section of rail that needs to be heated. As the heat is created from within the rail, it will migrate down between the individual heads to create uniform heating above the 98 degrees needed.

The magnetic induction technology was first developed in the 1980's but is now available in a size that is usable for Rail Heaters. The heating heads would be quickly install to the rail by means of a clamping device, installed between the rail ties.

The present invention functions through a variety of controls. The control unit shall be housed in a free standing stainless steel weather proof enclosure of sufficient size as to accommodate: 1. Power disconnects, fusing and voltage filter; 2. Power supply section with outs for up to 30 field induction heads. This can be accomplished in two versions, a single large power I generator or a rack of individual cards, one for each head. The overall system pricing can be held low with the use of “Off the Self” control cards that are now being produced for magnetic induction cooking hotplates; 3. A small PLC shall be installed to govern the system total performance in the field. This unit will issue instructions to the control cards and power supply to control the amperage sent to the induction heads. This will allow for the optimum electrical power saving given weather and or train conditions; 4. Rail temperature sending units shall supply the PLC with data regarding rail overall temperature; 5. An external thermal temperature sensing unit will supply the PLC the ambient temperature so that the system will know when freezing conditions are present; 6. Two external snow detection units shall be used to detect when snow is present. One located above the control cabinet and one at the track bed to detect when snow or ice is dropped by passing trains; 7. A GFI device will be installed to ensure that any field short is detected for safety shutdown reasons; 8. An internal cabinet ambient temperature control unit shall be installed to keep the control components at designed performance levels in below freezing weather events; 9. System contactors, relays, and drivers shall be used for induction head control.

When considering the programming unit of the present invention, the PLC unit will activate the induction heads and power the total array creating heat within the rails until the system track temperature set point (adjustable) is reached. At this point, the heads will shut off and the rail temperature will begin to drop through a dead band (adjustable) until the lower temperature threshold point is reached. The PLC will then repower the induction head and take it to the rail temperature set point again. This process will continue as long as the snow detectors are indicating snow is present. An optional time window for heating the rail after the snow detectors have dropped out will be available to ensure the track bed is free of snow and ice. In this manner, the overall system heads will pulse on and off to reduce the total system electrical amperage to the lowest level possible.

Should the PLC detect that a passing train over the induction heads has drastically reduced the rail temperature by means of the air turbulence generated by the train or the snow and ice dropped; the unit will respond by raising the wattage delivered to each head of a short time to restore the rail temperature set point. In this way the unit is self-adjusting to not only control the total system amperage, but also ensure the track bed and switch are ready for the next train.

The overall system control system shall have the capability to be viewed from a remote location via a cellular modem connection to the internet. This interface shall allow for the monitoring of the equipment, system diagnostics, and or changing the system programming from that remote point.

The wiring of the individual heads shall be accomplished by means of flexible armored cables fitted with quick disconnects that attach to two parallel conduit arrays that lay to the side of the rails in the ballast stone. There shall be a small junction box for each of the quick disconnects induction head connection points. This conduit array shall be a rigged device so that it can be set aside should ties need to be replaced at the site and will remain reusable. Unlike existing system now used in the Rail Road Industry, the induction heads will not be required to be removed from the rails and then put back in place when a Track Tamper Machine passes over the switch for normal track maintenance.

The induction heads shall be attached to the rail by means of a quick connection rail clamping unit. The clamp will require no changes to the rail in the field and shall allow the head to be moved to multiple locations in the switch bed to accommodate variances in track layout. The heads can be used on the outer body of the main rails or can be placed at the “Moving Switch Point” to maximize overall system efficiency. The body of the head shall be constructed of Aluminum angle iron with the induction coil potted in a non-conductive binder to ensure that track and train vibrations do not affect the performance. The potting of the coil will also make the head water proof and form an insulation barrier to guard against electrical shorting in the field wiring.

The “crib” area is referred to as the area between the ties that the linkage arms are located that attach to the Switch Motor that move the rails in the switch. Should this area become impacted with snow and ice the linkage arms are prevented from movement and the switch is disabled. This area can be heated by use of an induction head attached to a steel plate that covers the area. Again all the same features and control benefits of the main induction heads are relative to this section of the system.

This program has been mandated by the Federal Government to track train movements across all railroads in real time. To accomplish this, Railroad Signal Systems use “Track Circuits” and inject low level voltage into the track that is not allowed to be affected by other systems or hardware. As each of the induction heads are insulated from the rail by means of its insulated wire and disconnect plug, the system will not allow for conductive shorting of the rails. The heating systems that are now used in the industry often provide ground paths through the metal parts and or cables which defeat “track circuits” used in modern “Positive Train Control signaled territory”.

On all Rail Road Bridges across the industry, Lift Rail Joints are required for the parting of the rails when the bridge is opened. During winter months, snow and ice fall into the pockets when the bridge is opened. As the bridge is closed back up if this snow and ice prevents the rail from reseating, rail traffic is held up until the pockets can be cleaned out and the rails reseated. By clamping the small induction head to the pocket plate steel on the bridge, the pockets can now he heated in the same manner as rail switches and the pockets will be self-cleaning at the site.

In order to function, low frequency “E” heads require a large mass of steel configured into what is typically shaped like the letter E. It is necessary to construct these units out of a large mass of steel (up to eight inches thick) due to the low power needed to establish enough thermal heat to be effective for melting snow and ice in the track bed. In order to accommodate the bulk of the E Head, large amounts of ballast stone are needed to be removed from between the track ties to fit the heads into place. As track maintenance machines called “Tampers” run over the area where the heads are located, the tamper will dump ballast stone back into the area where the heads are located. Should a heavy fright trail pass over the heads, the weight of the trains will press down on the rail/E head and is likely to damage the unit between the rail and the stone. Also, the bulk of the E Heads will not lend it to be mounted on the side of the rails in switching areas. For this reason, this technology has not been used in heavy freight traffic lines in the USA.

The E Heads are used on light commuter lines in Europe as long as it is understood that additional effort is undertaken to keep the ballast stone removed from under the heads.

For these reasons the small, thin profile of the powerful magnetic inductive coils described in this patent offer superior performance and flexibility to the rail industry.

### BRIEF DESCRIPTION OF THE DRAWINGS

FIG. 1 is an illustration of the overall system of the present invention.

FIG. 2 is an illustration of one of the plurality of induction heating units.

FIG. 3 is an illustration of the electrical connection between the power supply card and the heating head.

FIG. 4 is an illustration of the perspective view of the heating head.

FIG. 5A is an illustration of a sectional view of the heating head when attached to the at least one train track rail.

FIG. 5B is another illustration of a sectional view of the heating head when attached to the at least one train track rail.

FIG. 6 is an illustration of the system control unit, wherein the wireless communication device is electronically connected to the system control unit.

FIG. 7 is an illustration of the present invention being used with the at least one train track rail, wherein the second temperature sensor is in thermal communication with the at least one train track rail.

FIG. 8 is an illustration of the heating head.

FIG. 9 is an illustration of the present invention being used with the at least one train track rail, wherein the heating head and the first temperature sensor is in thermal communication with the at least one train track rail.

FIG. 10 is an illustration of the present invention being used as a coal car heater.

FIG. 11 is an illustration of a perspective view of the crib heater.

FIG. 12 is an illustration of an exploded perspective view of the heating head.

FIG. 13 is an illustration of the present invention being used as a tank wall heater.

FIG. 14 is another illustration of an exploded perspective view of the heating head.

FIG. 15 is an illustration of oil-filled case used in the present invention.

### DETAIL DESCRIPTIONS OF THE INVENTION

All illustrations of the drawings are for the purpose of describing selected versions of the present invention and are not intended to limit the scope of the present invention.

The present invention introduces a heating system that prevents a train track from freezing or accumulating snow during cold weather conditions. By utilizing the present invention, the trains are ensured to have a clear train track at all times regardless of the weather conditions. In doing so, the present invention utilizes a method of providing induction heat sufficient enough to melt ice or snow.

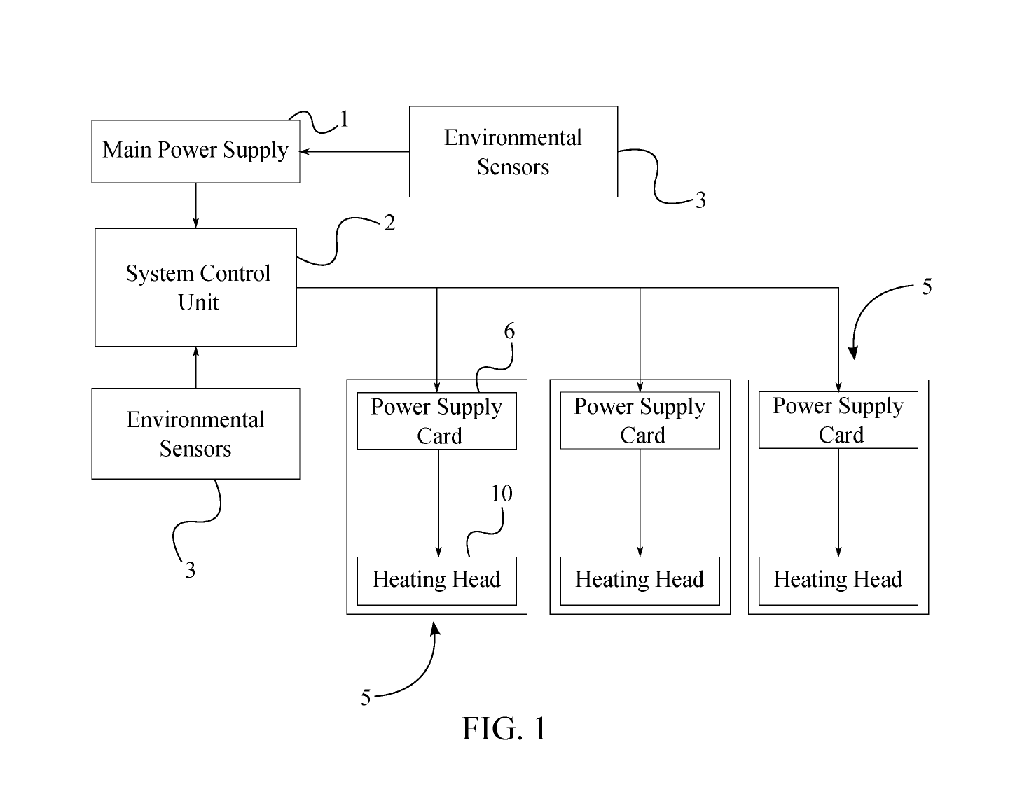

The present invention comprises a main power supply 1, a system control unit 2, a plurality of environmental sensors 3, and a plurality of induction heating units 5. The main power supply 1 provides, the necessary power for the remainder of the components of the present invention. In the preferred embodiment of the present invention, the main power supply 1 is a 120V alternating current power supply. However, in other embodiments of the present invention, other comparable power supply methods can be utilized. The system control unit 2 acts as a central hub that is used to control different functionalities of the present invention. In particular, the system control unit 2 allows the user to simultaneously monitor, and control each of the plurality of induction heating units 5 individually. In order to do so, the system control unit 2 is designed with a plurality of physical controls, a physical power disconnect and other comparable components. The plurality of physical components enables the user to manually adjust the operating specifications of the present invention. On the other hand, the physical power disconnect allows the user to manually shut down the present invention instantly. The plurality of environmental sensors 3 is utilized to maintain a constant feedback from the environment the present invention is being used in. As seen in FIG. 1, the plurality of environmental sensors 3 is electronically connected to the system control unit 2 so that the present invention can be adjusted to adapt accordingly. Based upon the feedback received from the plurality of environmental sensors 3, the present invention activates the plurality of induction heating units 5 to provide heat to the train track. Each of the plurality of induction heating units 5, which is identical to each other, is connected in parallel to each other so that a constant voltage is maintained across each of the plurality of induction heating units 5. The parallel connection is also beneficial to have individual control of each of the plurality of induction heating units 5 so that heat can be provided only to the areas that require external intervention which also minimizes the overall energy usage. The ability to individually control each of the plurality of induction heating units 5 is also beneficial when repairing or replacing one of the plurality of induction heating units 5. In order to provide the required heat, each of the plurality of induction heating units 5 comprises a power supply card 6 and a heating head 10. The power supply card 6 controls the amperage conducted to the heating head 10. In order to transfer the electrical power from the power supply card 6 to the heating head 10, the power supply card 6 is electrically connected to the heating head 10. The heating head 10 is sufficiently sized to fit along a train track rail or underneath a common crossing of the train track. The system control unit 2 is electronically connected to the power supply card 6 for each of the plurality of induction heating units 5 allowing the user to control the heating head 10. In the preferred embodiment of the present invention, the power supply card 6 has a plurality of filters to eliminate radio frequency noise that is a common occurrence in high frequency induction systems. For functionality purposes, the main power supply 1 is electrically connected to the system control unit 2 and the power supply card 6 for each of the plurality of induction heating units 5.

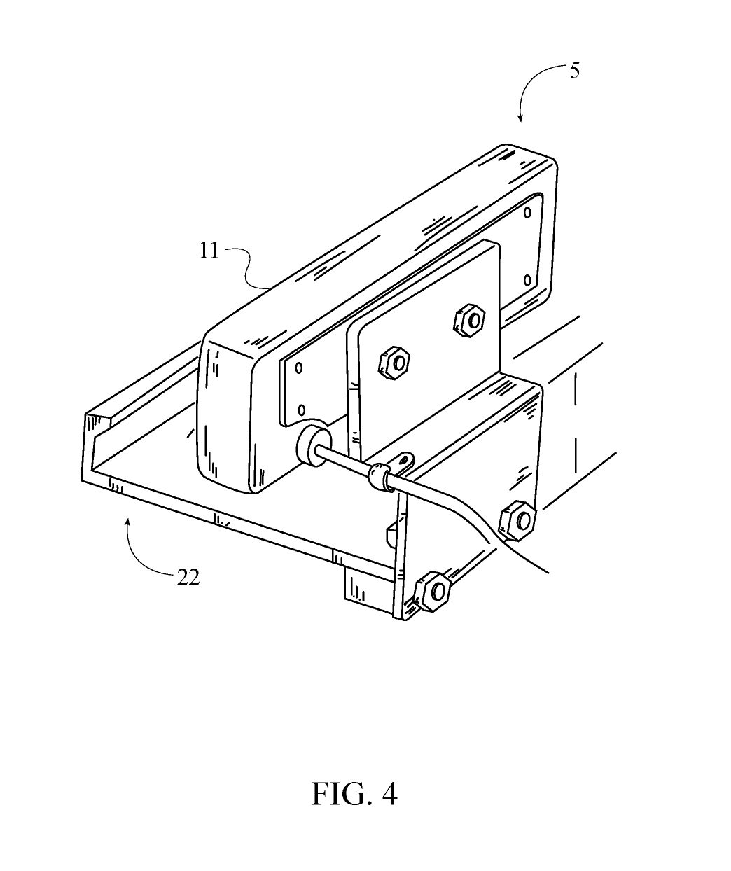

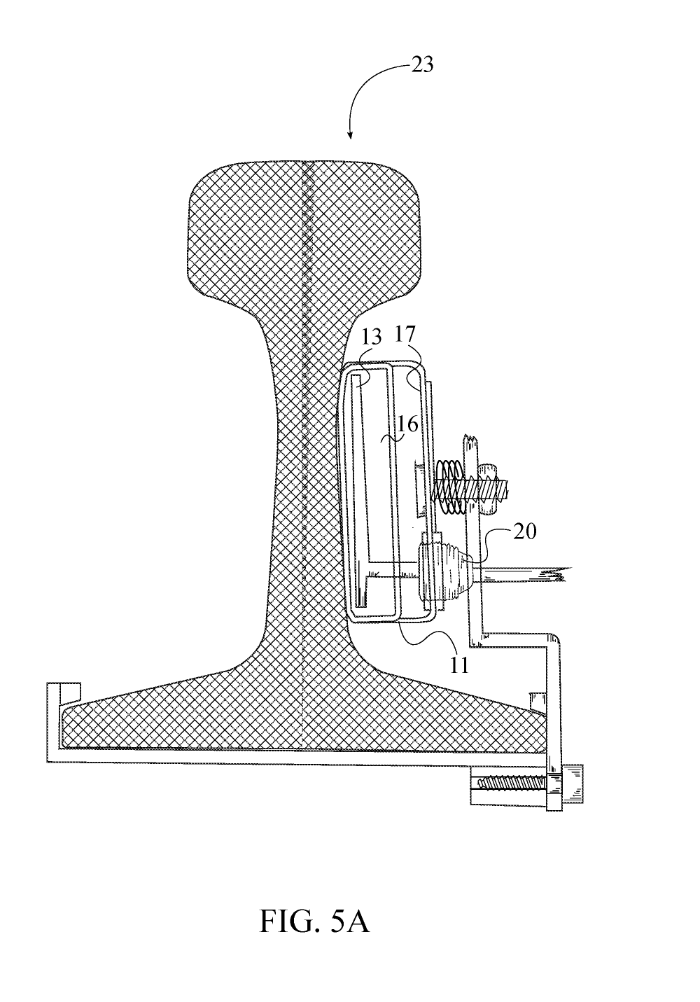

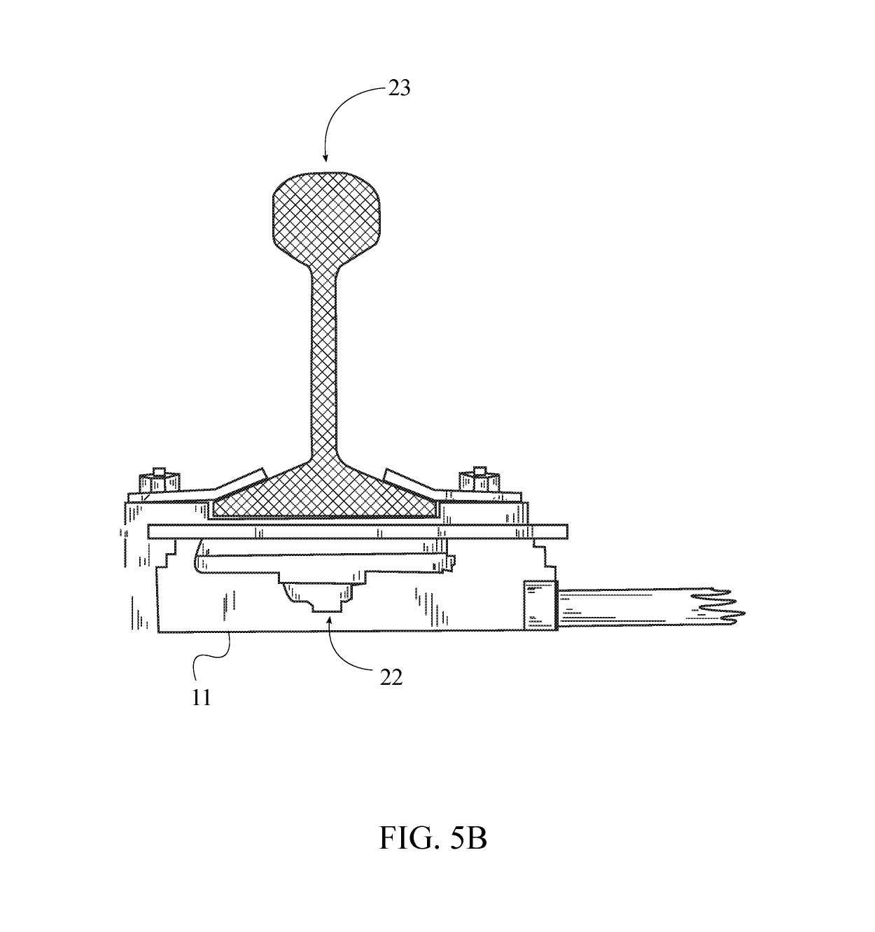

In order to provide the heat as necessary, the heating head 10 of each of the plurality of induction heating units 5 needs to be positioned adjacent to at least one train track rail 23. As seen in FIG. 4, each of the plurality of induction heating units 5 further comprises an attachment mechanism 22 which is used to position the heating head 10. The attachment mechanism 22 allows the heating head 10 to be positioned appropriately without drilling, cutting, or adjusting the at least one train track rail 23. More specifically, the heating head 10 is mounted onto the at least one train track rail 23 with the attachment mechanism 22. The attachment mechanism 22 can vary in different embodiments of the present invention. As an example, the attachment mechanism 22 can be a clamp system in one embodiment of the present invention. If the clamp system is being used, the clamp system is used to position the heating head 10 such that the movement of the trains travelling along the at least one train track rail 23 is not hindered. The clamps of the clamp system can vary according to the position the heating head 10 is attached to. As an example, the size and shape of a clamp being positioned under the at least one train track rail 23 is different from the size and shape of a clamp being positioned along a side of the at least one train track rail 23. In another embodiment of the present invention, the attachment mechanism 22 can be a screw and bolt system. As seen in FIG. 5B, other attachment mechanisms such as a magnetic holding system or magnetic disks can also be used to mount the heating head 10 onto the at least one train track rail 23. Moreover, adhesive and other comparable methods can also be used as the attachment mechanism 22.

Since the generated heat needs to effectively reach the at least one train track rail 23, the heating head 10 for each of the plurality of induction heating units 5 is in thermal communication with the at least one train track rail 23. The size of the heating head 10 can vary in size and shape in different embodiments of the present invention. In order to heat the at least one train track rail 23 in its entirety, the heating head 10 for each of the plurality of induction heating units 5 is distributed along the at least one train track rail 23 so that a majority of the at least one train track rail 23 is heated through the plurality of induction heating units 5.

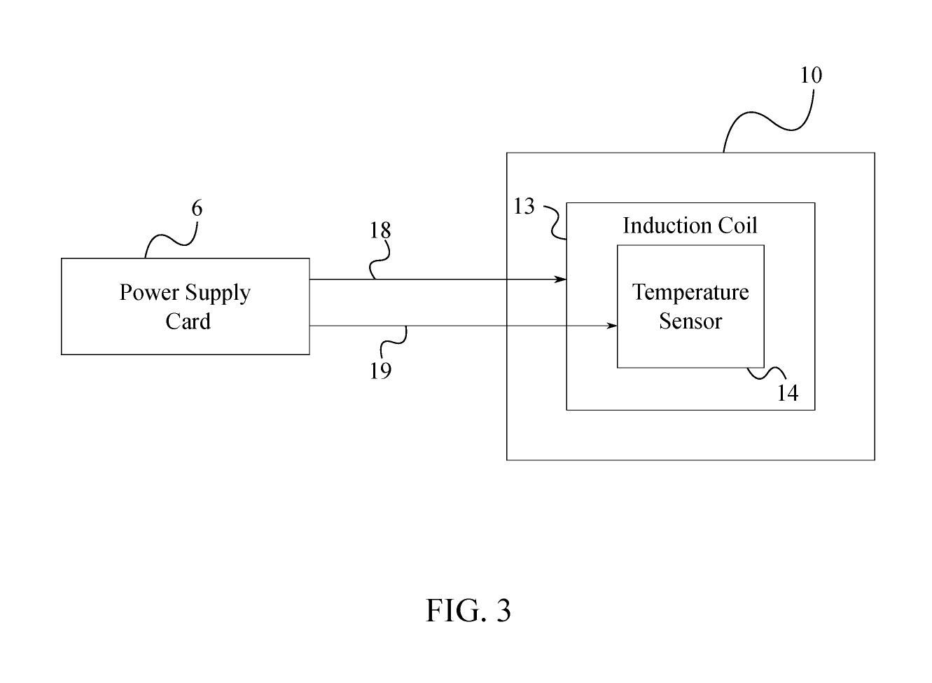

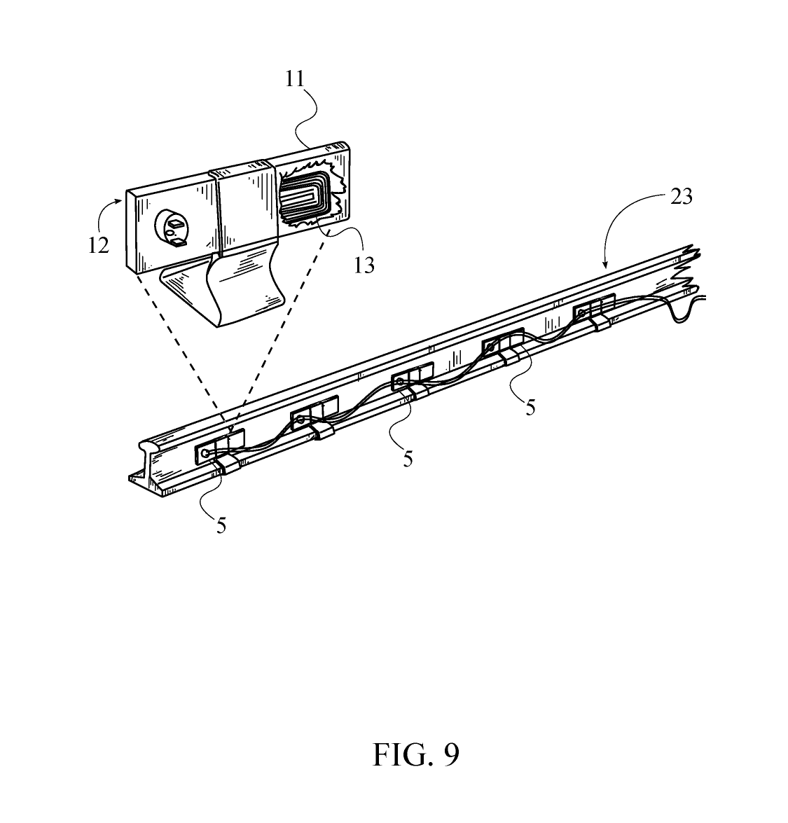

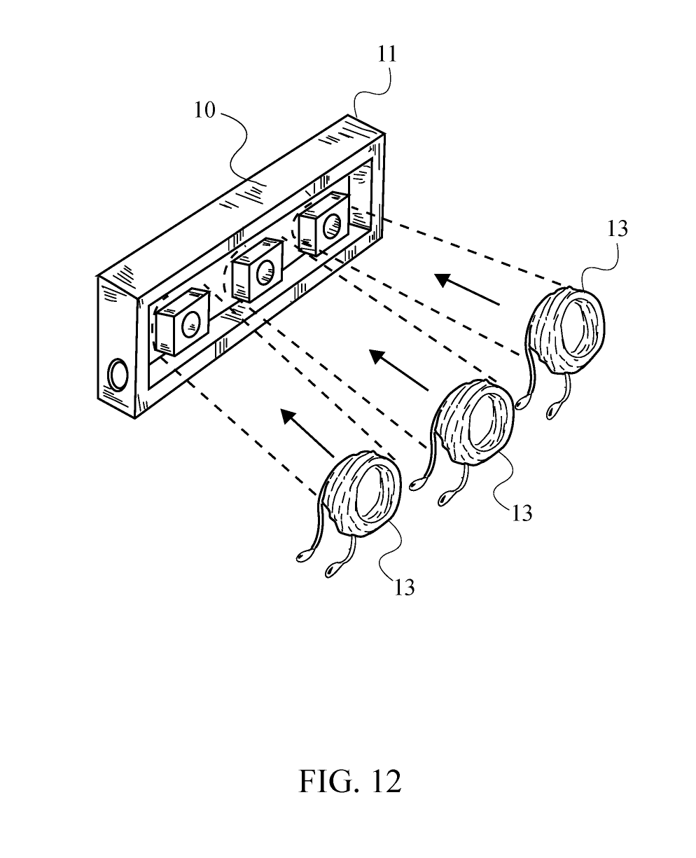

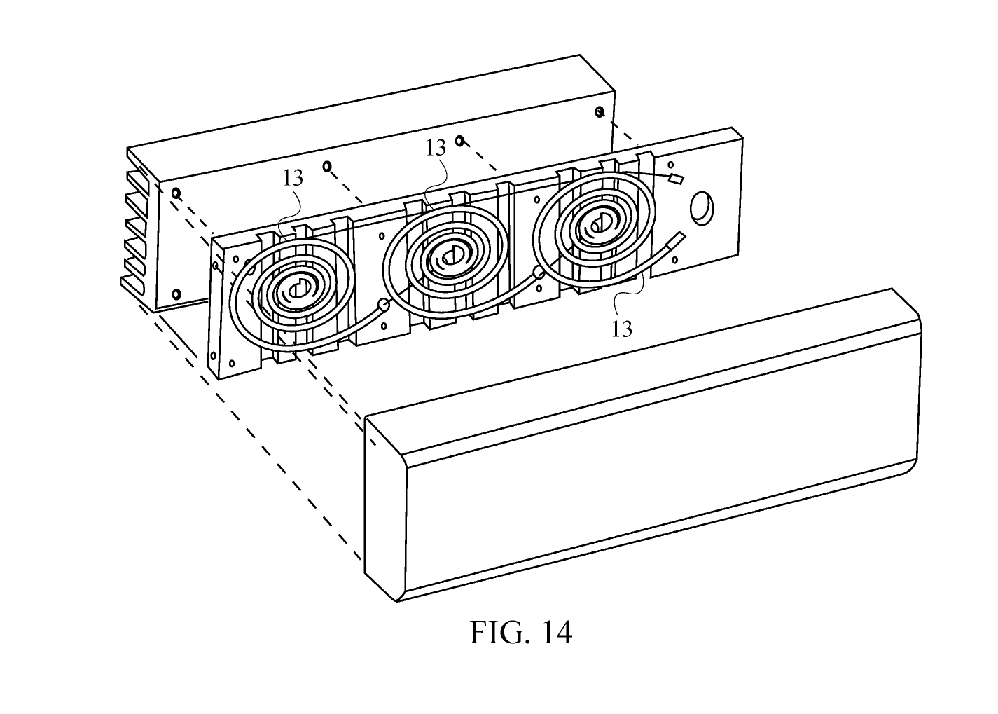

When considering the heating head 10 by itself, the heating head 10 comprises a waterproof housing 11, an induction coil 13, and a first temperature sensor 14 as seen in FIG. 3. The waterproof housing 11 is intended to protect the induction coil 13 and the first temperature sensor 14 from potentially harmful weather conditions. More specifically, the waterproof housing 11 isolates the electrical components of the heating head 10 from hazards such as water, vibration, fast travelling projectiles, falling debris, and other potential hazards. In order to do so, the induction coil 13 and the first temperature sensor 14 are mounted within the waterproof housing 11. The induction coil 13 is appropriately positioned within the waterproof housing 11 to effectively induce eddy currents on the at least one train track rail 23. The waterproof housing 11 is manufactured from rigid non-conducting materials. The material properties ensure that no eddy currents are induced in the heating head 10 when the induction coil 13 is in use. The induction coil 13, which is a pancake coil in the preferred embodiment of the present invention, is electrically connected to the power supply card 6. The pancake shape of the induction coil 13 is illustrated in FIG. 12 and FIG. 14. Moreover, the first temperature sensor 14 is also electrically connected to the power supply card 6 and is used to prevent the heating head 10 from overheating. In another embodiment of the present invention, a bimetal switch can also be used instead of the first temperature sensor 14. In order to accurately record data from the induction coil 13, the first temperature sensor 14 is in thermal connection with the induction coil 13. In addition to the induction coil 13 and the first temperature sensor 14, the heating head 10 further comprises an eddy current deflecting magnetic shield device 17 which is also mounted within the waterproof housing 11. The eddy current deflecting magnetic shield device 17 is positioned such that the induction coil 13 is positioned in between a contact wall 12 of the waterproof housing 11 and the eddy current deflecting magnetic shield device 17. When the heating head 10 is mounted onto the at least one train track rail 23 as discussed earlier, the contact wall 12 is attached against the at least one train track rail 23 as illustrated in FIG. 9. The positioning of the eddy current deflecting magnetic shield device 17 ensures that the generated eddy current field is directed towards the at least one train track rail 23. The eddy current deflecting magnetic shield device 17 can be made of Inconel or other comparable materials.

Each of the plurality of induction heating units 5 further comprises a first shielded wire 18 and a second shielded wire 19 which extend from the power supply card 6 towards the heating head 10. The first shielded wire 18 electrically connects the power supply card 6 to the induction coil 13. On the other hand, the second shielded wire 19 electrically connects the power supply card 6 to the first temperature sensor 14. The properties of the first shielded wire 18 and the second shielded wire 19 ensure that radio frequency noise has no interference to railroad signal systems. Moreover, the first shielded wire 18 and the second shielded wire 19 prevent conductive shorting at the at least one train track rail 23 when the present invention is in use.

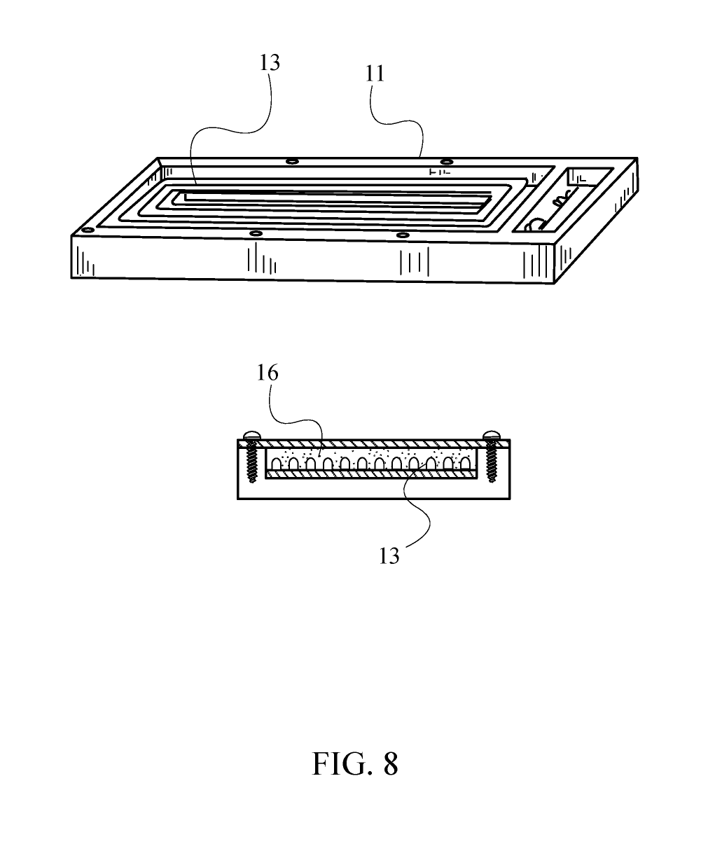

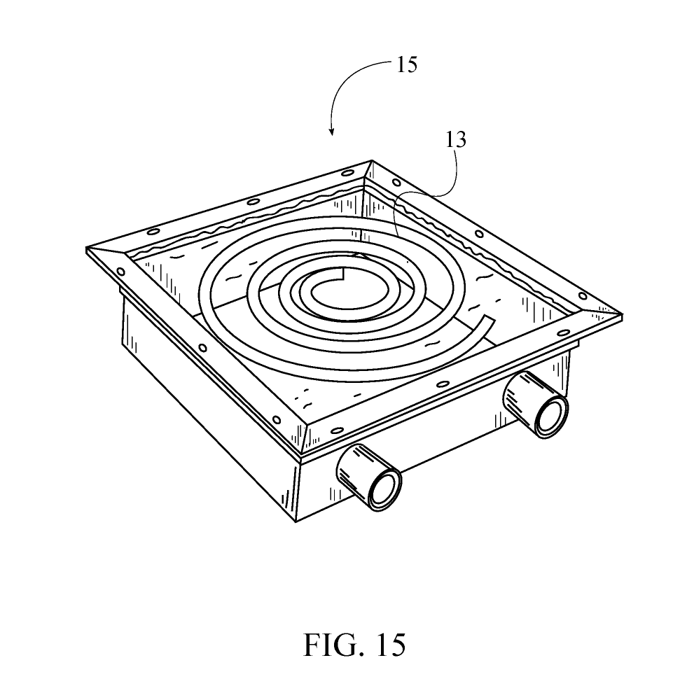

When the present invention is in use, the induction coil 13 generates a considerable amount of heat. As an example, if the temperature drops to below freezing temperatures the induction coil 13 needs to be powered at high levels. Therefore, precautionary measures need to be taken to protect the induction coil 13. In the preferred embodiment of the present invention, the heating head 10 further comprises an oil-filled case 15. As illustrated in FIG. 15, the oil-filled case 15 is used with the induction coil 13. The oil-filled case 15 comprises a pan with the ability to receive the induction coil 13. Therefore, the induction coil 13 is placed within the oil-filled case 15. When the induction coil 13 generates heat, a quantity of oil of the oil-filled case 15 pulls out heat from the induction coil 13 and transfers the heat to a plurality of outer walls of the oil-filled case 15. Next, an outer surface of the oil-filled case 15 dissipates the heat to the atmosphere. In another embodiment of the present invention, the heating head 10 can comprise an electrically-insulative potting 16. In such instances, the induction coil 13 is mounted within the waterproof housing 11 by the electrically-insulative potting 16 as seen in FIG. 8. In other words, the waterproof housing 11 is filled with the electrically-insulative potting 16 so that the induction coil 13 is waterproof and also has the ability to withstand vibrations. In other embodiments of the present invention, a heat sink case can be used along with the induction coil 13. The heat sink case pulls in heat from the induction coil 13 and transfers the heat to cooling fins positioned outside of the heating head 10. Similarly, in another embodiment of the present invention, an air-cooled case can be used along with the induction coil 13. The air-cooled case comprises a fan that pulls in cold air from the atmosphere and directs the cold air across the induction coil 13.

As previously discussed, the present invention utilizes the plurality of environmental sensors 3 in order to adjust heating levels accordingly. The plurality of environmental sensors 3 comprises a second temperature sensor 4. The second temperature sensor 4 is specifically used to maintain a constant feedback of the environment the present invention is being used in. In order to do so, the second temperature sensor 4 is in thermal communication with the at least one train track rail 23. Moreover, the second temperature sensor 4 is electronically connected to the system control unit 2. Therefore, the user can take appropriate measures through the system control unit 2 according to the input from the second temperature sensor 4. Since the second temperature sensor 4 is used to maintain a constant temperature at the at least one train track rail 23, the second temperature sensor 4 is beneficial in maximizing energy usage. In addition to the second temperature sensor 4, one of the plurality of environmental sensors 3 can be, but is not limited to, a snow detection device. Moreover, one of the plurality of environmental sensors 3 can be, but is not limited to, an ambient outside temperature sensor. In general, the plurality of environmental sensors 3 can be used to detect snowfall, ice accumulation, rail temperature, and other related environmental data. Additionally, sensors to detect the proximity of a train and sensors to scan identification badges can also be included along with the plurality of environmental sensors 3.

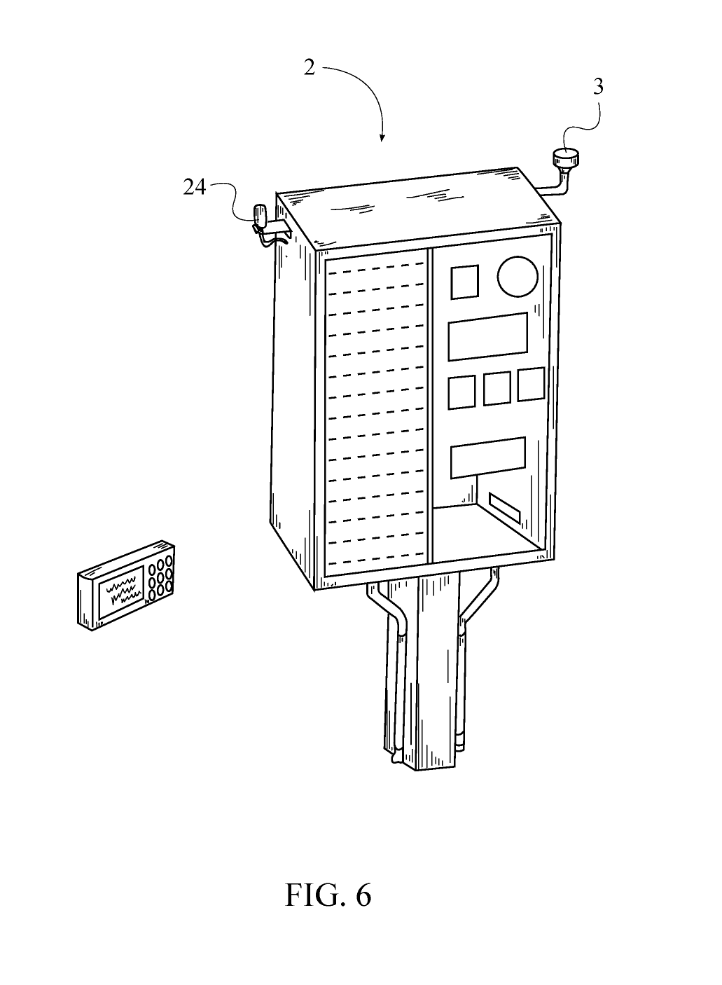

The present invention further comprises a wireless communication device 24 as shown in FIG. 6. The wireless communication device 24 is electronically connected to the system control unit 2 so that the present invention can be remotely controlled according to user preference. Wireless communication methods which can be, but is not limited to, a local area wireless computer networking, Radio Frequency transmission, and other comparable methods can be used along with the wireless communication device 24. The wireless communication device 24 acts as a two-way communication device. More specifically, the user can send and receive relevant information through the wireless communication device 24.

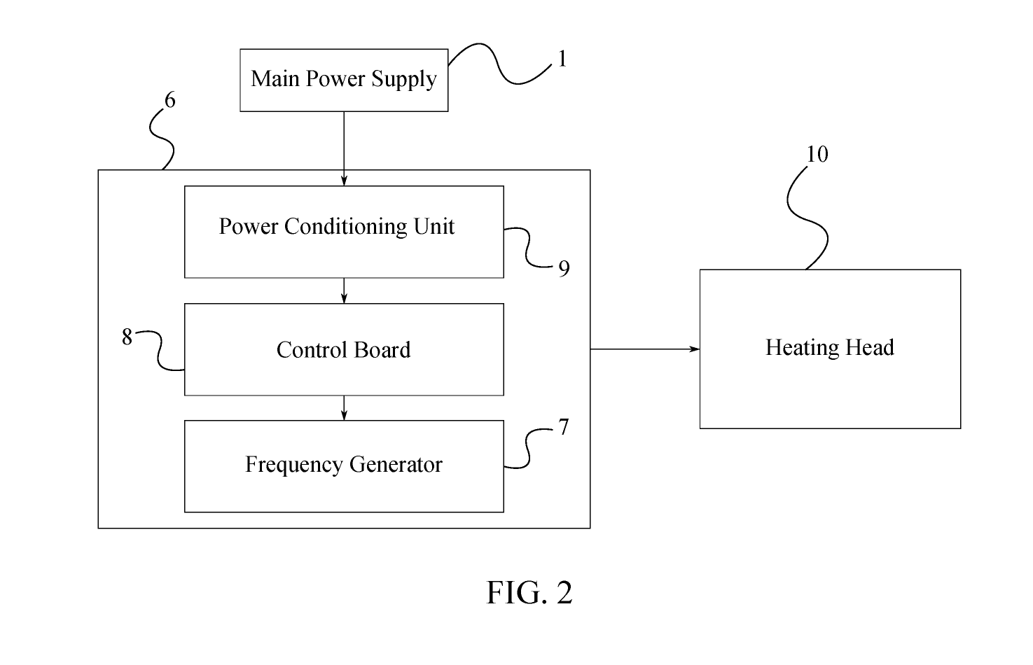

In the preferred embodiment of the present invention, the power supply card 6 comprises a frequency generator 7, a control board 8, and a power conditioning unit 9 as seen in FIG. 2. The frequency generator 7 is used to vary the frequencies according to the required power levels. As a result of the varying power levels, different amounts of heat can be generated at the induction coil 13. The frequency generator 7 is also useful for maximizing overall energy savings. The power conditioning unit 9 acts as a noise filter to remove noise spikes. Additionally, the power conditioning unit 9 also protects the internal components from voltage spikes that can occur due to lightening or comparable scenarios. In general, the power conditioning unit 9 prevents electrical failures and modulates the power accordingly. In order to supply power to the plurality of induction heating units 5, the main power supply 1 is electrically connected to the power conditioning unit 9 for each of the plurality of induction heating units 5. In order to transfer the power received from the main power supply 1 to the frequency generator 7 and the control board 8, the power conditioning unit 9 is electrically connected to the frequency generator 7 and the control board 8. The control board 8 is electronically connected to the frequency generator 7 such that the user is allowed to control the frequency generator 7 through the control board 8. The heat emitted from the heating head 10 is dependent on the input from the frequency generator 7 since the frequency generator 7 is electrically connected to the heating head 10.

Since the heating head 10 is mounted onto the at least one train track rail 23, the plurality of induction heating units 5 undergo a considerable amount of vibration with train movement. In order to address the issue, each of the plurality of induction heating units 5 further comprises a vibration dampener 20 as shown in FIG. 5A. When the heating head 10 is being mounted, the heating head 10 is mounted to the at least one train track rail 23 via the vibration dampener 20. The vibration dampener 20 helps the heating head 10 be stationary in a required operating position, despite fluctuations in the at least one train track rail 23 caused by passing trains and varying temperatures. The vibration dampener 20 can be, but is not limited to, a rubberized pad, a set of springs, a set of pistons, rubber bumpers, and other comparable methods.

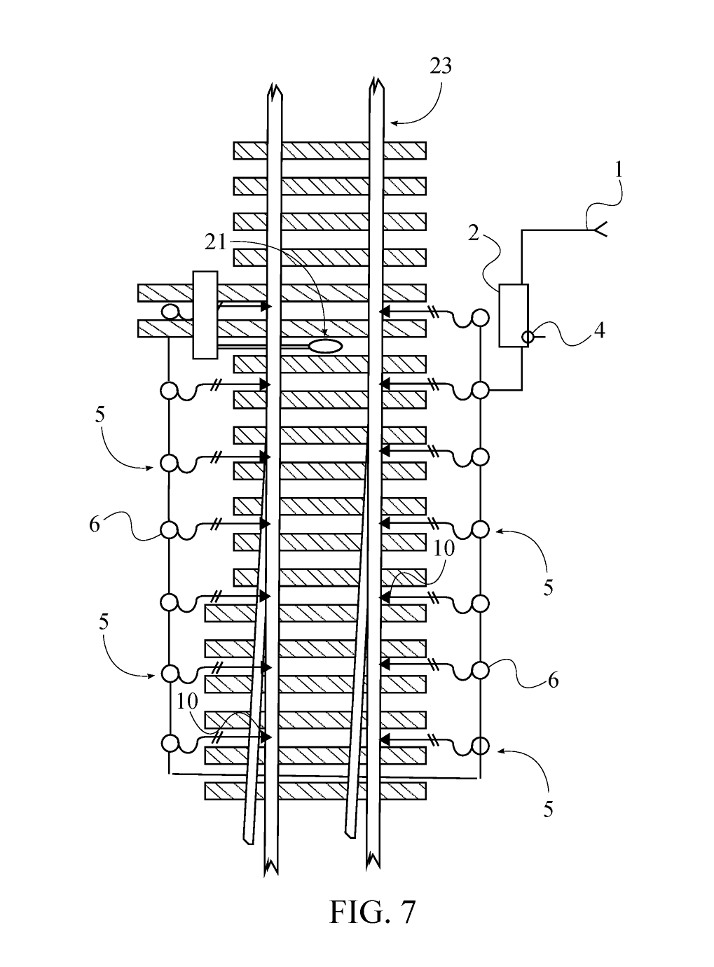

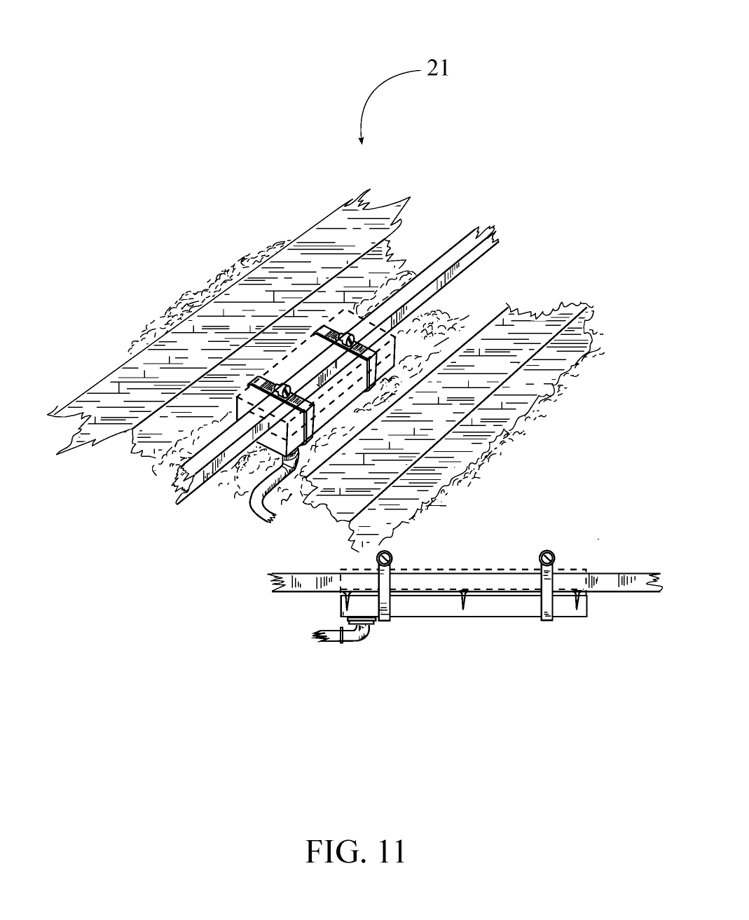

The present invention also comprises a crib heater 21 as illustrated in FIG. 7 and FIG. 11. The plurality of induction heating units 5 is electronically connected to the crib heater 21 so that the crib heater 21 can also be utilized for heat emitting purposes. When considering the positioning, the crib heater 21 is positioned adjacent the at least one train track rail 23 and opposite to the heating head 10. More specifically, the crib heater 21 is positioned adjacent to a switch motor drive rod of a railroad. Similar to the plurality of induction heating units 5, the crib heater 21 also comprises an induction coil which is used to prevent the accumulation of frozen material adjacent the at least one train track rail 23. As an additional safety measure, an aluminum plate can be used along with the crib heater 21 such that the crib heater 21 is protected from snow and other harmful weather conditions.

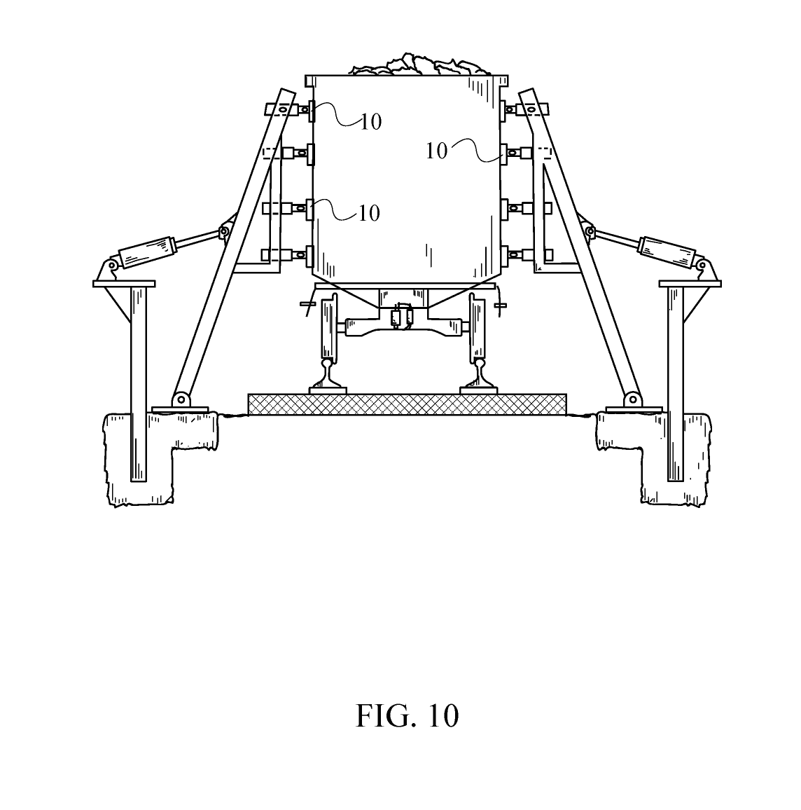

Even though the present invention is intended to be used with the at least one train track rail 23, the present invention can also be used as a coal car heater as shown in FIG. 10. When the present invention is used as a coal car heater, the heating head 10 of each of the plurality of induction heating units 5 is positioned along a side of a coal car. By doing so, the ice formed on the coal car is thawed. Therefore, the coal car can be inverted and the coal can be dumped onto a conveyer belt system in its entirety.

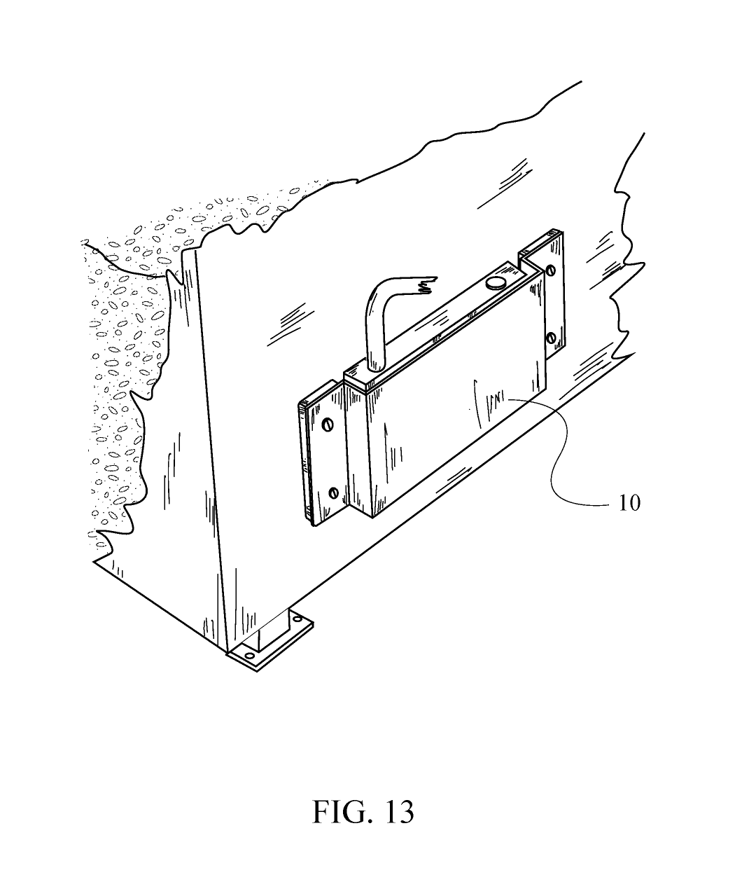

The present invention can also be used to heat a liquid storage tank as shown in FIG. 13. In doing so, the heating head 10 from each of the plurality of induction heating units 5 is placed on an outer wall of a tank such that the liquid within the tank is heated. By utilizing the present invention, the required heat can be provided to the tank without changing the overall structure of the tank. Therefore, the need to heat the liquid before use is eliminated.

Although the invention has been explained in relation to its preferred embodiment, it is to be understood that many other possible modifications and variations can be made without departing from the spirit and scope of the invention as hereinafter claimed.

What is claimed is:

1. A distributable inductive heating system comprises:
a main power supply;
a system control unit;
a plurality of environmental sensors;
a plurality of induction heating units;
each of the plurality of induction heating units comprises a power supply card and a heating head;
the plurality of environmental sensors being electronically connected to the system control unit;
the system control unit being electronically connected to the power supply card for each of the plurality of induction heating units;
the main power supply being electrically connected to the system control unit and the power supply card for each of the plurality of induction heating units; and
the power supply card being electrically connected to the heating head.

2. The distributable inductive heating system as claimed in claim 1, wherein the plurality of induction heating units is electrically connected in parallel with each other.

3. The distributable inductive heating system as claimed in claim 1 comprises:
each of the plurality of induction heating units further comprises an attachment mechanism; and
the heating head being mounted onto at least one train track rail by the attachment mechanism.

4. The distributable inductive heating system as claimed in claim 3, wherein the attachment mechanism is a clamp system.

5. The distributable inductive heating system as claimed in claim 3, wherein the attachment mechanism is a screw and bolt system.

6. The distributable inductive heating system as claimed in claim 1 comprises:
the heating head for each of the plurality of induction heating units being in thermal communication with at least one train track rail; and
the heating head for each of the plurality of induction heating units being distributed along the at least one train track rail.

7. The distributable inductive heating system as claimed in claim 1 comprises:
the heating head comprises a waterproof housing, an induction coil, and a first temperature sensor;
the induction coil and the first temperature sensor being electrically connected to the power supply card;
the induction coil and the first temperature sensor being mounted within the waterproof housing; and
the first temperature sensor being in thermal communication with the induction coil.

8. The distributable inductive heating system as claimed in claim 7 comprises:
each of the plurality of induction heating units further comprises a first shielded wire and a second shielded wire;
the first shielded wire electrically connecting the power supply card to the induction coil; and
the second shielded wire electrically connecting the power supply card to the first temperature sensor.

9. The distributable inductive heating system as claimed in claim 7 comprises:
the heating head further comprises an oil-filled case; and
the induction coil being placed within the oil-filled case.

10. The distributable inductive heating system as claimed in claim 7 comprises:
the heating head further comprises an electrically-insulative potting; and
the induction coil being mounted within the waterproof housing by the electrically-insulative potting.

11. The distributable inductive heating system as claimed in claim 7, wherein the induction coil is configured as a pancake coil.

12. The distributable inductive heating system as claimed in claim 1 comprises:
the plurality of environmental sensors comprises a second temperature sensor;
the second temperature sensor being in thermal communication with at least one train track rail; and
the second temperature sensor being electronically connected to the system control unit.

13. The distributable inductive heating system as claimed in claim 1 comprises:
a wireless communication device; and
the wireless communication device being electronically connected to the system control unit.

14. The distributable inductive heating system as claimed in claim 1 comprises:
the power supply card comprises a frequency generator, a control board, and a power conditioning unit;
the main power supply being electrically connected to the power conditioning unit for each of the plurality of induction heating units;
the power conditioning unit being electrically connected to the frequency generator and the control board;
the control board being electronically connected to the frequency generator; and
the frequency generator being electrically connected to the heating head.

15. The distributable inductive heating system as claimed in claim 1, wherein the main power supply is an alternating current power supply.

16. The distributable inductive heating system as claimed in claim 1 comprises:
each of the plurality of induction heating units further comprises a vibration dampener; and
the heating head being mounted to at least one train track rail via the vibration dampener.

17. The distributable inductive heating system as claimed in claim 1 comprises:
the heating head comprises a waterproof housing, an induction coil, and an eddy current deflecting magnetic shield device;
a contact wall of the waterproof housing being attached against at least one train track rail;
the induction coil and the eddy current deflecting magnetic shield device being mounted within the waterproof housing; and
the induction coil being positioned in between the contact wall and the eddy current deflecting magnetic shield device.

18. The distributable inductive heating system as claimed in claim 1 comprises:
a crib heater;
the plurality of induction heating units being electronically connected to the crib heater; and
the crib heater being positioned adjacent to at least one train track rail, opposite to the heating head.

19. The distributable inductive heating system as claimed in claim 1, wherein one of the plurality of environmental sensors is a snow detection device.

20. The distributable inductive heating system as claimed in claim 1, wherein one of the plurality of environmental sensors is an ambient outside temperature sensor.
